(19) United States
(12) Patent Application Publication
(10) Pub. No.: US 2020/0061949 A1
(43) Pub. Date: Feb. 27, 2020

(54) MOTION GENERATION DEVICE, PRESS DEVICE, MOTION GENERATION METHOD, AND MOTION GENERATION PROGRAM

(71) Applicant: KOMATSU INDUSTRIES CORPORATION, Kanazawa-shi, Ishikawa (JP)

(72) Inventors: Masayuki OKAMOTO, Hakusan-shi, Ishikawa (JP); Kiichiro KAWAMOTO, Komatsu-shi, Ishikawa (JP); Hisanori TAKEUCHI, Nomi-shi, Ishikawa (JP); Yuto ECHIGO, Kanazawa-shi, Ishikawa (JP)

(21) Appl. No.: 16/462,607

(22) PCT Filed: Jan. 23, 2018
(86) PCT No.: PCT/JP2018/001943

§ 371 Date: May 21, 2019

(30) Foreign Application Priority Data
Mar. 24, 2017 (JP) 2017-059137

(51) Int. Cl. B30B 15/00; B30B 15/26; B30B 15/02; G05B 19/18

(52) U.S. Cl. CPC B30B 15/0041; B30B 15/0035; G05B 2219/41348; B30B 15/026; G05B 19/186; B30B 15/26

(57) ABSTRACT

A motion generation device generates motion of a slide in a press device configured to perform press molding by driving the slide up and down using a servo motor as a drive source. The motion generation device includes an acquisition component and a second motion generator. The acquisition component acquires data related to a change in a load exerted on the slide in press molding using a first motion. The second motion generator generates a second motion from the first motion based on the change in the load.

### CROSS-REFERENCE TO RELATED APPLICATIONS

This application is a U.S. National stage application of International Application No. PCT/JP2018/001943, filed on Jan. 23, 2018. This U.S. National stage application claims priority under 35 U.S.C. § 119(a) to Japanese Patent Application No. 2017-059137, filed in Japan on Mar. 24, 2017, the entire contents of which are hereby incorporated herein by reference.

### BACKGROUND

### Field of the Invention

The present invention relates to a motion generation device, a press device, a motion generation method, and a motion generation program.

### Background Information

In recent years, press devices featuring a servo motor have been used in press molding. With a servo press device such as this, position control is performed in which the slide position is controlled according to the rotation angle of the crankshaft or the like.

Meanwhile, carbon fiber reinforced plastic (CFRP), which is light in weight and has excellent strength, is attracting attention in sports, industrial applications, and so on. CFRP is made by mixing carbon fibers into a resin, and a vehicle body or the like is manufactured by press molding.

In the press molding of a resin material or the like, there are situations in which the shape is stabilized by cooling while exerting a load on the heated material for a certain length of time, but since the servo press device is under position control, if the material undergoes heat shrinkage due to cooling, there is a possibility that the load will decrease and the desired product shape and performance cannot be obtained.

In order to compensate for a decrease in load it is possible, for example, to manually create a slide motion that artificially compensates for diminished load by using the free motion function of the servo press device, but this entails a trial and error process using the material that will actually be used in press molding, so material costs and labor are involved.

Also, it is conceivable, for example, to use the servo press device that performs load control described in JP-A 2013-237062, and to compensate for a decrease in load by sequentially feeding back the load value.

### SUMMARY

However, when the load control is performed as described above, the servo motor is repeatedly started and stopped (forward rotation and reverse rotation) in a loaded state, and overload of the servo motor is likely to occur. Therefore, when a high pressing force is required over a long period, a large-capacity servo motor is necessary, which drives up the cost.

In view of the above problems encountered in the past, it is an object of the present invention to provide a motion generation device, press device, motion generation method, and motion generation program with which cost can be lowered and press molding can be carried out under the appropriate load.

The motion generation device according to the present invention is a motion generation device for generating motion of a slide in a press device that performs press molding by driving the slide up and down using a servo motor as a drive source, said motion generation device comprising an acquisition component and a second motion generator. The acquisition component acquires data related to the change in the load exerted on the slide in press molding using a first motion. The second motion generator generates a second motion from the first motion on the basis of the change in the load.

The press device according to another invention is a press device for press molding a material using an upper die and a lower die, said press device comprising a slide, a servo motor, a servo controller, a load sensor, and a second motion generator. The upper die is attached to the lower face of the slide. The servo motor is used as a drive source for the slide. The servo controller controls the servo motor on the basis of a specific motion to raise and lower the slide. The load sensor detects the load exerted on the slide in press molding. The second motion generator generates a second motion from the first motion on the basis of the change in the load exerted on the slide in press molding using the first motion.

The motion generation method according to another invention is a motion generation method for generating motion of a slide in a press device that performs press molding by driving the slide up and down using a servo motor as a drive source, wherein a second motion is generated from a first motion on the basis of the change in the load exerted on the slide in press molding using the first motion.

The motion generation program according to another invention is a motion generation program for generating motion of a slide in a press device that performs press molding by driving the slide up and down using a servo motor as a drive source, wherein a second motion is generated from a first motion on the basis of the change in the load exerted on the slide in press molding using the first motion.

The present invention provides a motion generation device, a press device, motion generation method, and motion generation program with which cost can be lowered and press molding can be carried out under the appropriate load.

### BRIEF DESCRIPTION OF DRAWINGS

FIG. 1 is a simplified front view of a press system in a first embodiment of the present invention;

FIG. 2 is a block diagram of the control configuration of the press system in FIG. 1;

FIG. 3 is a flowchart of the operation of the press system in FIG. 1;

FIG. 4 is a graph of basic motion;

FIG. 5 is a graph showing an example of load waveform data;

FIG. 6 is a graph showing the relation between pressing load and pressing extension with the press device in FIG. 1;

FIG. 7 is a graph of correction motion;

FIG. 8 is a graph of a state in which the load decrease amount has been compensated for by a correction motion with respect to the load waveform data in FIG. 5;

FIG. 9 is a block diagram of the control configuration of a press device according to a second embodiment of the present invention; and

FIG. 10 is a flowchart of the operation of the press device of FIG. 9.

### DETAILED DESCRIPTION OF EMBODIMENT(S)

The motion generation device in an embodiment of the present invention will now be described with reference to the drawings.

### 1. Embodiment 1

### 1-1. Configuration

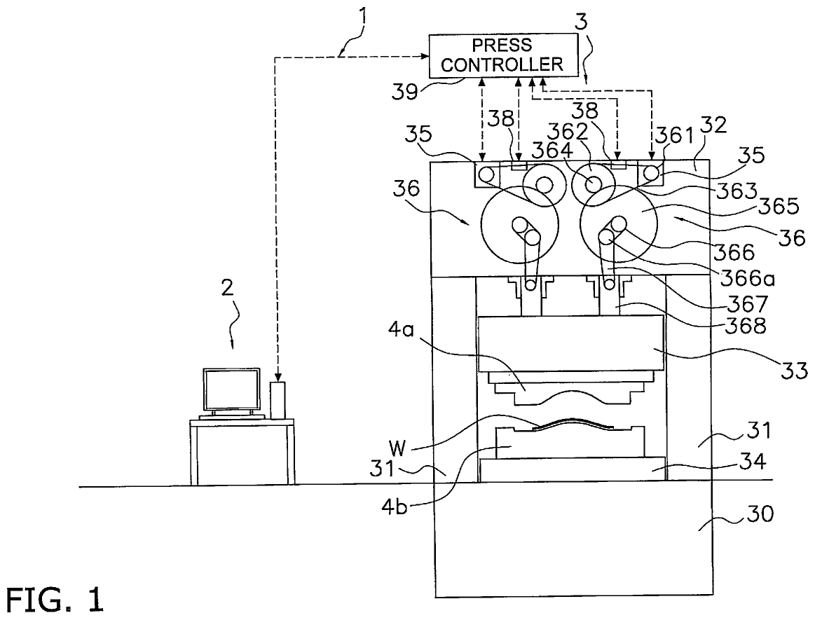

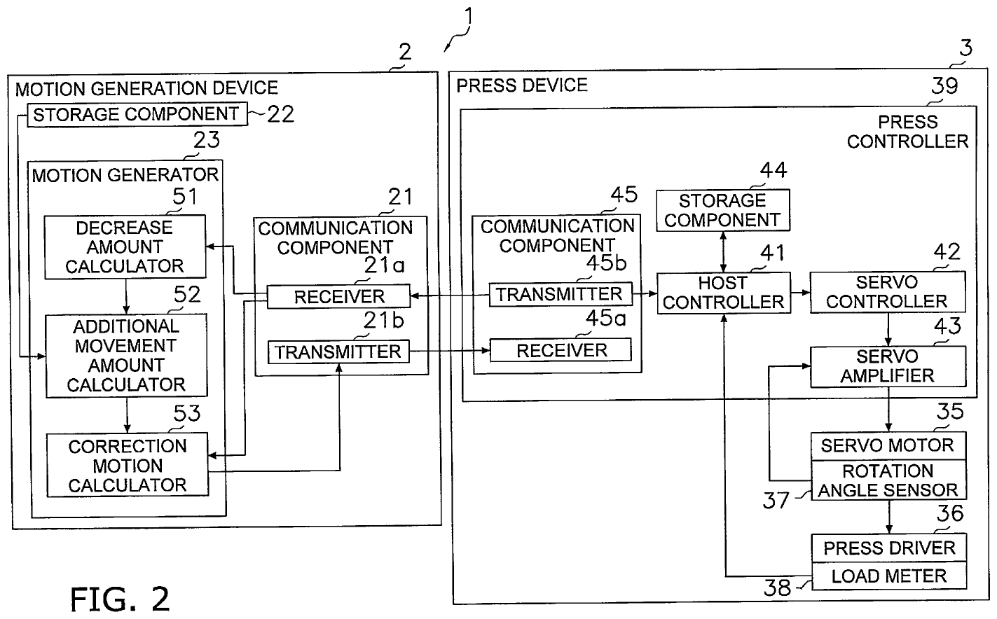

FIG. 1 is a diagram of the configuration of a press system 1 in Embodiment 1. FIG. 2 is a block diagram of the control configuration of the press system 1. The press system 1 in this embodiment has a motion generation device 2 and a press device 3. The motion generation device 2 generates a correction motion to be exerted on the press device 3 based on load waveform data obtained when preliminary press molding was performed using a basic motion S₀ in the press device 3. The press device 3 performs press molding of an actual product (also referred to as main molding) using this correction motion.

### 1-1-1. Press Device

First, the configuration of the press device 3 will be described.

The press device 3 performs press molding on a resin material W such as CFRP, for example. A stampable sheet formed from carbon fiber is used as the resin material W, for example. The resin material W is preheated and placed in the dies (the upper die 4a and the lower die 4b), and is cooled while being press molded.

The press device 3 mainly comprises a bed 30, uprights 31, a crown 32, a slide 33, a bolster 34, servo motors 35, press drivers 36, a rotation angle sensor 37 (see FIG. 2), load meters 38, and a press controller 39.

The bed 30 is embedded in the floor and constitutes the base of the press device 3. The uprights 31 are columnar members, and four of them are disposed on the bed 30. The four uprights 31 are disposed so as to form rectangular apexes in plan view.

The crown 32 is supported above by the four uprights 31. The slide 33 is suspended below the crown 32 so as to be able to move up and down. On the lower face of the slide 33, an upper die 4a is removably attached by die clamps (not shown). The bolster 34 is disposed below the slide 33 and on the bed 30. A lower die 4b is placed on the upper side of the bolster 34.

The servo motors 35 are the drive source for driving the slide 33, and is provided to the crown 32. In FIG. 1, the servo motors 35 are provided at two locations on the right and left.

The press drivers 36 are provided on the left and right sides of the crown 32, and convert the rotational motion of the servo motors 35 into up and down motion to raise and lower the slide 33. As shown in FIG. 1, the press drivers 36 each have a small pulley 361, a large pulley 362, a timing belt 363, a small gear 364, a large gear 365, an eccentric shaft 366, a connecting rod 367, and a plunger 368. The small pulley 361 is fixed to the rotating shaft of the servo motor 35. The large pulley 362 is rotatably supported by the crown 32. The timing belt 363 is wound around the small pulley 361 and the large pulley 362. The small gear 364 is attached to the large pulley 362, concentrically with the large pulley 362. The large gear 365 is rotatably supported by the crown and meshes with the small gear 364. The eccentric shaft 366 has an eccentric portion 366a, and is attached to the center of the large gear 365. The large gear 365 and the eccentric shaft 366 are concentric with each other, and their rotational axes are the same. The upper end of the connecting rod 367 is rotatably attached to the eccentric portion 366a of the eccentric shaft 366. The upper portion of the plunger 368 is attached to the lower end of the connecting rod 367, and the slide 33 is attached to the lower portion of the plunger 368.

When the servo motor 35 is driven, the small pulley 361 rotates, and the large pulley 362 also rotates via the timing belt 363. The rotation of the large pulley 362 causes the small gear 364 to rotate, and the large gear 365 and the eccentric shaft 366 rotate. The eccentric portion 366a of the eccentric shaft 366 moves circularly around the axis of the eccentric shaft 366, and the connecting rod 367 moves up and down along with this circular movement. As the connecting rod 367 moves up and down, the plunger 368 connected to the connecting rod 367 also moves up and down, and the slide 33 moves up and down.

The rotation angle sensor 37 shown in FIG. 2 is a rotary encoder, for example, and is provided to the servo motor 35.

The load meters 38 detect the load that is exerted on the slide 33 (also referred to as the pressing load). The load meters 38 are strain gauges, for example, and are attached to the crown 32. The load meters 38 are disposed above the two plungers 368. The load exerted on the left side of the slide 33 is detected by the load meter 38 on the left side in FIG. 1, and the load exerted on the right side of the slide 33 is detected by the load meter 38 on the right side. The overall load exerted on the slide 33 can be found by totaling the values sensed by the two load meters 38.

The press controller 39 controls the servo motor 35 on the basis of position information from the rotation angle sensor 37. Data sensed by the load meter 38 is also inputted to the press controller 39.

### 1-1-2. Control Configuration of Press Device

As shown in FIG. 2, the press controller 39 of the press device 3 has a host controller 41, a servo controller 42, a servo amplifier 43, a storage component 44, and a communication component 45.

The host controller 41 issues a preliminary forming command based on the basic motion S₀ or an actual forming command based on the correction motion S to the servo controller 42.

The servo controller 42 instructs the servo amplifier 43 to execute the motion according to the command from the host controller 41. The servo amplifier 43 controls the servo motors 35 using the position detection results from the rotation angle sensors 37 on the basis of the motion (basic motion S₀ or correction motion S) instructed by the servo controller 42.

The rotation of the servo motors 35 drives the press drivers 36, the slide 33 moves up and down, and press molding is performed. The load exerted on the slide 33 in the press molding is sensed by the two load meters 38, and the sensed load is sent to the host controller 41. At the host controller 41, the sensed values of the two load meters 38 are added up to obtain load waveform data.

The storage component 44 stores the basic motion S₀ and the correction motion received from the motion generation device 2.

The communication component 45 communicates with the motion generation device 2. More precisely, the communication component 45 has a receiver 45a and a transmitter 45b. The transmitter 45b transmits the load waveform data during press molding with the basic motion S₀ and the basic motion S₀. The receiver 45a receives the correction motion S created by the motion generation device 2. Communication with the motion generation device 2 may be either wired or wireless.

### 1-1-3. Motion Generation Device

As shown in FIG. 1, the motion generation device 2 in this embodiment is a personal computer, for example, and generates motion of the slide 33 of the press device 3.

The motion generation device 2 has a communication component 21, a storage component 22, and a motion generator 23. The communication component 21 communicates with the communication component 45 of the press device 3. The communication component 21 has a receiver 21a that receives the basic motion S₀ and load waveform data transmitted from the press device 3, and a transmitter 21b that transmits the generated correction motion S.

The storage component 22 stores press extension amount information for the press device 3. The press extension amount information will be described in detail below.

The motion generator 23 has a decrease amount calculator 51, an additional movement amount calculator 52, and a correction motion calculator 53. The decrease amount calculator 51 calculates the load decrease amount ΔF on the basis of the load waveform data received from the press device 3. The additional movement amount calculator 52 calculates the slide additional movement amount ΔS from the load decrease amount ΔF on the basis of the press extension amount information (described below). The correction motion calculator 53 adds the slide additional movement amount ΔS to the basic motion S₀ to generate a correction motion S.

### 1-2. Operation

The operation of the press system 1 in this embodiment will now be described, and an example of the motion generation method of the present invention will also be described at the same time.

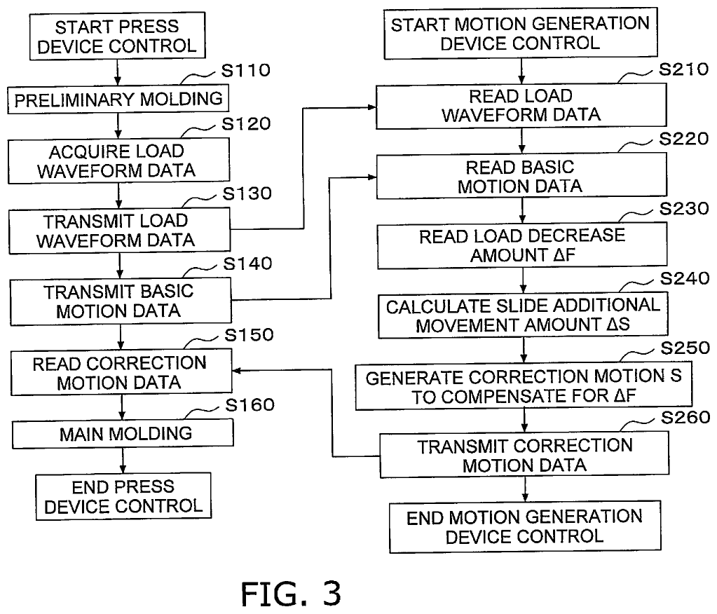

FIG. 3 is a diagram showing the operational flow of the press system 1, in which the left side shows the operational flow of the press device 3, and the right side shows the operational flow of the motion generation device 2.

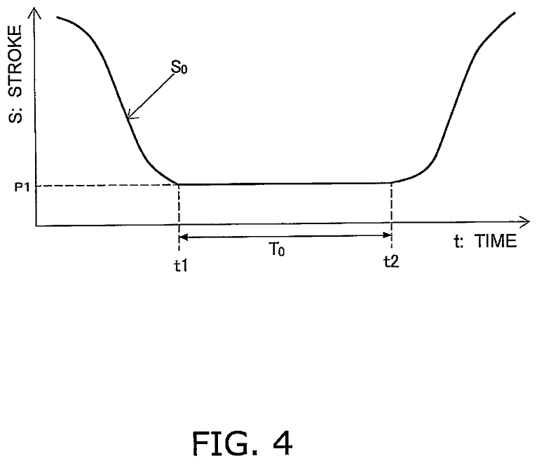

As shown in FIG. 3, preliminary molding is performed by the press device 3 in step S110. In this preliminary molding, press molding is performed on the basis of the basic motion S₀, using the resin material used for the actual product and the upper die 4a and the lower die 4b. The basic motion S₀ is shown in FIG. 4. In FIG. 4, the vertical axis is the stroke of the slide 33, and the horizontal axis is time. The basic motion S₀ is stored in the storage component 44. With the basic motion S₀, as shown in the graph, the servo motors 35 are controlled so as to stop the position of the slide 33 at the lower limit position P1 for a specific length of time T₀ (clock time t1 to t2). During this specific length of time T₀, the resin material is molded while being cooled. The basic motion S₀ may be set by an operator. For example, the motion during descent and ascent of the slide 33 may be predetermined, and the length of time T₀ may be set depending on the resin material to be press molded. This setting can be performed by an operator on a control panel (not shown) or the like.

Next, in step S120, the host controller 41 acquires the load waveform data. The load exerted on the slide 33 during preliminary molding is sensed by the two load meters 38, and the load waveform data can be obtained by adding together the values sensed by the two load meters.

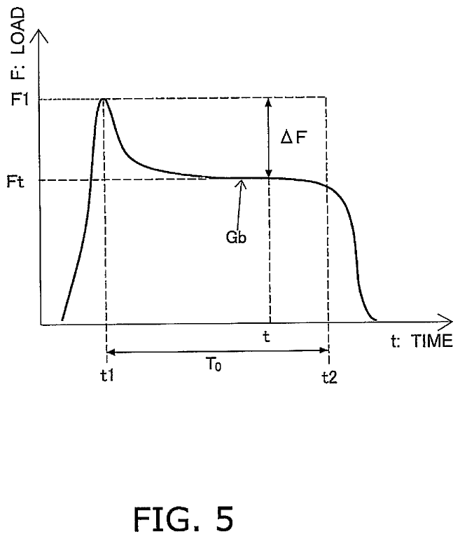

FIG. 5 is a graph of the load waveform data Gb. FIG. 5 shows the clock times t1 and t2 in the basic motion S₀. As shown in FIG. 5, the load exerted on the slide 33 is highest at the time t1, and drops off after that. This decrease in load occurs primarily due to shrinkage of the resin material caused by cooling while the slide 33 is being held at its lower limit position P1 (time t1 to t2).

Next, in step S130, the press controller 39 transmits the load waveform data Gb from the transmitter 45b to the motion generation device 2.

Then, in step S140, the press controller 39 transmits the basic motion S₀ used in the preliminary molding to the motion generation device 2.

In step S210, the motion generation device 2 receives the load waveform data via the receiver 21a, and reads this load waveform data Gb. Then, in step S220, the motion generation device 2 receives the basic motion S₀, and reads this basic motion S₀. The load waveform data Gb and the basic motion S₀ may be temporarily stored in the storage component 22.

Next, in step S230, the decrease amount calculator 51 reads the load decrease amount ΔF during load holding. As shown in FIG. 5, “during load holding” corresponds to the specific length of time T₀ (between t1 and t2) since the load exerted on the slide 33 reached its maximum value, and corresponds to how long the slide 33 is stopped at its lower limit position P1 (see FIG. 4). Since the load holding time thus corresponds to the specific length of time T₀, the load holding time can be varied by changing T₀ of the basic motion S₀ depending on the resin material to be press molded, the thickness of the product, and so forth. The load decrease amount ΔF is found by subtracting the actual load Ft at time t from the preset load F1. Consequently, the load decrease amount ΔF at time t is calculated. Step S230 corresponds to an example of the decrease amount calculation step. The preset load F1 is appropriately changed depending on the material to be used.

Next, in step S240, the additional movement amount calculator 52 calculates the slide additional movement amount ΔS on the basis of the load decrease amount ΔF and the press extension amount information. The press extension amount information is the relation between the press extension amount and the pressing load. Here, the relation between the press extension amount (also referred to as press respiration amount, deflection, or deformation amount) and pressing load will be described. Step S240 corresponds to an example of the correction amount calculation step.

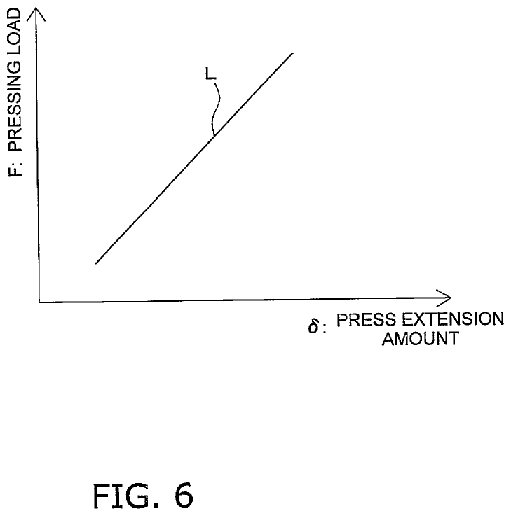

FIG. 6 is a graph of the relation between the pressing load F and the press extension amount δ (press extension amount information). In the graph of FIG. 6, the vertical axis is the pressing load and the horizontal axis is the press extension amount. The entire press device 3 extends in the up and down direction as the pressing load (also referred to as the sliding load) increases, on the basis of the rigidity of the press device 3. The relation between the pressing load and the amount of extension of the pressing device 3 can be expressed by the line L (F=k×δ+α) shown in FIG. 6, and the extension amount δ of the press device 3 is expressed by δ=(F−α)/k.

The values of k and α of the line L are values intrinsic to the press device 3, and can be found ahead of time by calculation or by attaching a linear sensor to the press device and conducting an experiment, for example. Since the extension amount δ of the press device 3 corresponds to the change in the position of the slide 33, the slide additional movement amount δS can be Δδ=ΔS, and can be expressed as ΔS=(ΔF−α)/k. That is, the load decrease amount calculated in step S230 can be converted into the slide additional movement amount.

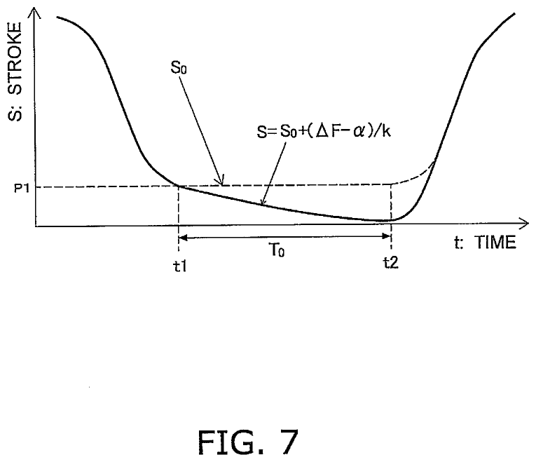

Next, in step S250 the correction motion calculator 53 adds ΔS to the basic motion S₀ and generates a correction motion S (=S₀+ΔS=S₀+(ΔF−α)/k) that compensates for ΔF. FIG. 7 is a graph of the correction motion S. In FIG. 7, the basic motion S₀ is indicated by a dotted line. As shown in FIG. 7, the correction motion S is set so that the position of the slide 33 falls below the basic motion S₀, so as to compensate for the decrease in load. Since the correction motion S thus results in the position of the slide 33 being below the lower limit position P1 of the basic motion S₀, the slide 33 is preferably positioned higher than bottom dead center at the lower limit position P1 of the basic motion S₀.

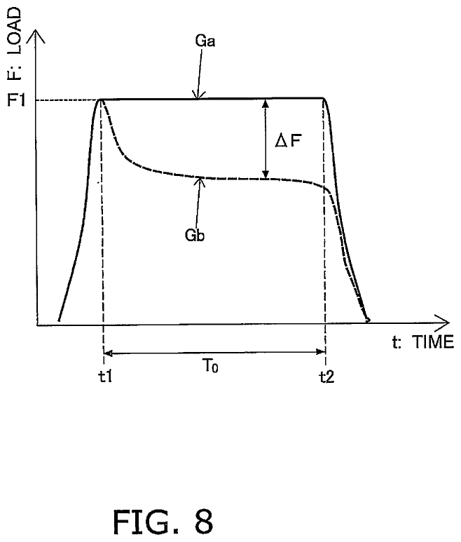

FIG. 8 is a graph of a state in which the load decrease amount ΔF has been compensated for by the correction motion S with respect to the load waveform data Gb shown in FIG. 5. The compensated load waveform data is indicated by the solid line Ga, and the load waveform data before compensation is indicated by the dotted line Gb. As shown in FIG. 7, even if the resin material cools and shrinks, a constant load F1 can be exerted on the resin during the specific length of time T₀ required for press molding. Step S250 corresponds to an example of the second motion calculation step.

Next, in step S260 the transmitter 21b of the motion generation device 2 transmits the correction motion S to the press device 3.

In step S150, the press device 3 receives the correction motion S with the receiver 45a, the correction motion S is read, and the correction motion S is stored in the storage component 44.

Next, in step S160 the host controller 41 instructs the servo controller 42 to perform actual molding on the basis of the correction motion S stored in the storage component 44. The servo controller 42 then transmits a command to the servo amplifier 43 on the basis of the correction motion S, and the servo motors 35 are driven. As a result, the press device 3 performs press molding of an actual product on the basis of the correction motion S.

### 1-3. Features and Effects, etc.

1-3-1

The motion generation device 2 in this embodiment is a motion generation device 2 for generating motion of a slide 33 of a press device 3 that performs press molding by driving a slide 33 up and down with servo motors 35 as the drive source, and comprises a receiver 21a (an example of an acquisition component) and a motion generator 23 (an example of a second motion generator). The receiver 21a acquires a load waveform data (an example of load change data) about the load exerted on the slide 33 during press molding using the basic motion S₀ (an example of a first motion). The motion generator 23 generates a correction motion S (an example of a second motion) from the basic motion S₀ on the basis of the decrease ΔF in the load (an example of a change in the load).

Thus, the basic motion S₀ can be corrected on the basis of the change in the load obtained as a result of performing press molding with the basic motion S₀, and a correction motion S that takes into account the change in the load can be generated. The servo motors 35 can be driven under position control produced by this correction motion S, and the press molding can be performed under an appropriate load. That is, press molding under an appropriate load can be performed by position control.

In the control of the servo motors 35 by position control, acceleration or deceleration is performed, but since there is no repeated starting and stopping as in the case of pressure control, the motor load is lower and servo motors with a smaller capacity can be employed.

Therefore, producing the correction motion S and performing press molding with this correction motion S allows press molding to be performed under the appropriate load at low cost, without using large capacity servo motors.

Also, since there is no need to adjust by trial and error, it is not necessary to consume extra materials to generate the proper motion, and costs can be reduced.

1-3-2

With the motion generation device 2 in this embodiment, the motion generator 23 has the additional movement amount calculator 52 (an example of a correction amount calculator) and the correction motion calculator 53 (an example of a second motion calculator). The additional movement amount calculator 52 calculates the slide additional movement amount ΔS (an example of a correction amount) of the basic motion S₀ on the basis of the load decrease amount ΔF (an example of a change in load). The correction motion calculator 53 calculates the correction motion S (an example of a second motion) from the basic motion S₀ using the slide additional movement amount ΔS.

This makes it possible to calculate the amount by which the slide 33 is additionally moved from the basic motion S₀, and to generate the correction motion S on the basis of this amount.

1-3-3

With the motion generation device 2 in this embodiment, the additional movement amount calculator 52 (an example of a correction amount calculator) calculates the additional movement amount ΔS (correction amount) so as to suppress the change in the load.

This makes it possible to generate motion of the slide 33 that can suppress changes in the load due to a change in the material being pressed.

1-3-4

With the motion generation device 2 in this embodiment, as shown in FIG. 5, the change in the load is a decrease from the preset load value F1.

This makes it possible to generate motion of the slide 33 that can suppress a decrease in the load due to shrinkage of the resin material.

1-3-5

The motion generation device 2 in this embodiment further comprises a decrease amount calculator 51. The decrease amount calculator 51 (an example of a change amount calculator) calculates the load decrease amount ΔF (an example of the amount of change in the load) from load waveform data (an example of data related to load change). On the basis of the relation between the extension amount of the press device 3 (an example of the amount of extension of the entire press device) and the load exerted on the slide 33, the additional movement amount calculator 52 (an example of a correction amount calculator) finds the extension amount Δδ from the load decrease amount ΔF, and the extension amount ΔS is used as the slide additional movement amount ΔS (an example of a correction amount). The correction motion calculator 53 generates a correction motion S (an example of a second motion) so as to move the slide 33 from the basic motion S₀ (an example of the first motion) by the extension amount ΔS.

Here, since the relation between the extension amount of the press device 3 (also referred to as the amount of extension of the entire press device 3) and the load exerted on the slide 33 is found in advance, the basic motion S₀ can be corrected using this relationship.

That is, by moving the position of the slide 33 from the basic motion S₀ and suppressing changes in the load, it is possible to compensate for the decrease ΔF in the load due to shrinkage of the material during press molding by the basic motion S₀, so there is less decrease in load, and press molding can be carried out with the load as uniform as possible.

1-3-6

With the motion generation device 2 in this embodiment, the amount of change in the load is the amount of decrease in the load, and the correction motion calculator 53 (an example of a second motion calculator) moves the slide 33 downward from the basic motion S₀ by the slide additional movement amount ΔS (correction amount).

This allows the position of the slide 33 to be moved downward so as to compensate for the decrease in load, and allows press molding to be performed with as uniform a load as possible.

1-3-7

With the motion generation device 2 in this embodiment, the basic motion S₀ (an example of a first motion) is motion that controls the servo motors 35 so as to hold the slide 33 at its lower limit position P1 while press molding the material.

By keeping the lower limit position P1 constant during preliminary molding with the basic motion S₀, a correction motion S can be generated that takes into account the decrease ΔF in the load that accompanies shrinkage of the material occurs.

1-3-8

The motion generation method in this embodiment is an example of a motion generation method for generating motion of a slide 33 of a press device 3 that performs press molding by driving a slide 33 up and down using servo motors 35 as a drive source, wherein a correction motion S (an example of a second motion) is generated from a basic motion S₀ on the basis of the decrease ΔF in the load (an example of a change in the load) exerted on the slide 33 during press molding using the basic motion S₀ (an example of a first motion).

Thus, a correction motion S can be generated that takes into account the change in load, by correcting the basic motion S₀ on the basis of the change in the load obtained as a result of performing press molding by the basic motion S₀. Then, the servo motors 35 can be driven by under position control by the correction motion, and press molding can be performed under the proper load. That is, press molding under the proper load can be performed by position control.

In the control of the servo motors 35 by the position control, acceleration or deceleration is performed, but since starting and stopping are not repeatedly performed as in the case of pressure control, the motor load is lower and servo motors having a smaller capacity can be employed.

Therefore, generating the correction motion S and performing press molding with this correction motion S allows the press molding to be performed under the proper load and at low cost, without using large-capacity servo motors.

1-3-9

The motion generation method in this embodiment comprises a step S240 (an example of a correction amount calculation step) and a step S250 (an example of a second motion calculation step). In step S240, the slide additional movement amount ΔS of the basic motion S₀ (an example of a correction amount) is calculated on the basis of the decrease ΔF in the load exerted on the slide 33 (an example of a change in load) during press molding using the basic motion S₀ (an example of a first motion). In step S250, the correction motion S (an example of a second motion) is calculated from the basic motion S₀ using the slide additional movement amount ΔS.

This makes it possible to calculate the amount of additional movement of the slide 33 from the basic motion S₀, and allows the correction motion S to be generated on the basis of this amount.

### 2. Embodiment 2

The press device 103 in Embodiment 2 of the present invention will now be described. In Embodiment 1 the motion generation device 2 generates the correction motion, but in Embodiment 2 the press device 103 generates the correction motion. The press device 103 of Embodiment 2 differs from the press device 3 in the configuration of the press controller. Therefore, in Embodiment 2 the description will focus on the differences from Embodiment 1. Components having the same functions as in Embodiment 1 will be numbered the same and will not be described again in detail.

### 2-1. Configuration

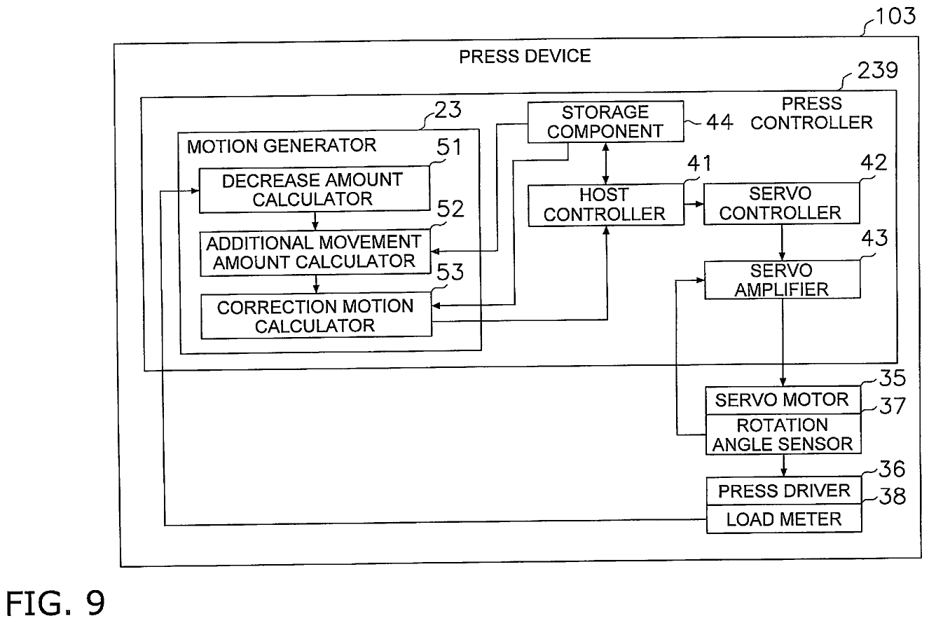

FIG. 9 is a block diagram of the configuration of the press device 103 in Embodiment 2. A press controller 239 of the press device 103 in Embodiment 2 further comprises a motion generator 23, as compared with the press controller 39 of the press device 3.

The storage component 44 stores the basic motion S₀, and the relation between the pressing load and the press extension amount. The load waveform data acquired by the load meter 38 during preliminary molding is sent to the decrease amount calculator 51 of the motion generator 23. The correction motion S generated by the correction motion calculator 53 is sent to the host controller 41 and stored in the storage component 44.

### 2-2. Operation

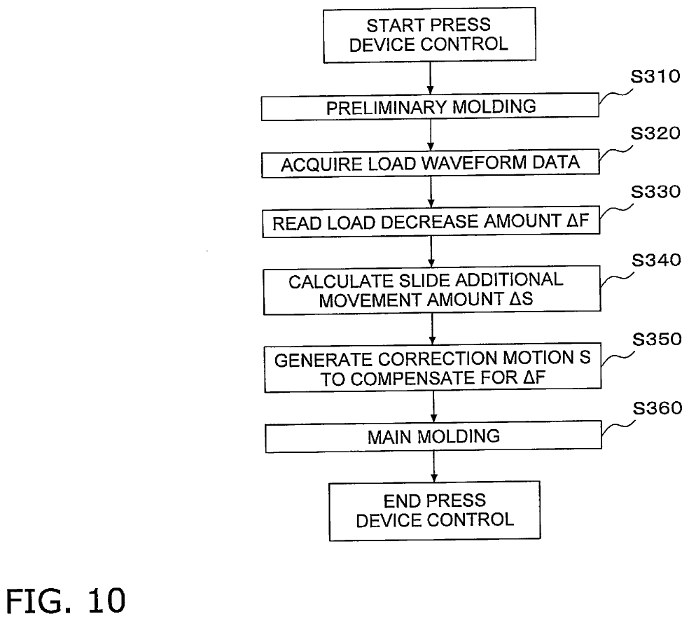

The operation of the press device 3 in Embodiment 2 will now be described, and an example of the motion generation method of the present invention will be given at the same time. FIG. 10 is a flowchart of the operation of the press device 103 in Embodiment 2.

As shown in FIG. 10, as preliminary molding, in step S310 press molding is performed on the material used for the actual product, on the basis of the basic motion S₀ (see FIG. 4).

Next, in step S320 the decrease amount calculator 51 of the motion generator 23 acquires load waveform data (see FIG. 5) from the value sensed by the load meter 38 during preliminary molding.

Next, in step S330 the decrease amount calculator 51 calculates the load decrease amount ΔF during load holding (see FIG. 5). Step S330 corresponds to an example of a decrease amount calculation step.

Next, in step S340 the additional movement amount calculator 52 calculates the slide additional movement amount ΔS on the basis of the load decrease amount Δ, and the relation between the pressing load and the press extension amount (see FIG. 6). Step S340 corresponds to an example of a correction amount calculation step.

Next, in step S350 the correction motion calculator 53 adds ΔS to the basic motion S₀ and generates a correction motion S (=S₀+ΔS=S₀+(ΔF−α)/k) to compensate for ΔF. The generated correction motion S is stored in the storage component 44. Step S350 corresponds to an example of a second motion calculation step.

Next, in step S360 the host controller 41 instructs the servo controller 42 to perform a pressing operation using the correction motion S stored in the storage component 44. The servo controller 42 transmits an instruction to the servo amplifier 43 on the basis of the correction motion S, and the servo motors 35 are driven. Consequently, the press device 103 performs press molding of the actual product on the basis of the correction motion S.

### 2-3. Features and Effects, etc.

The press device 103 of Embodiment 2 includes the effects described in Embodiment 1.

2-3-1

The press device 103 of Embodiment 2 is a press device for press molding a material with an upper die 4a and a lower die 4b, and comprises the slide 33, the servo motors 35, the servo controller 42 (an example of a servo controller), the load meters 38 (an example of a load sensor), and the motion generator 23 (an example of a second motion generator). The upper die 4a is attached to the lower face of the slide 33. The servo motors 35 are used as the drive source for the slide 33. The servo controller 42 controls the servo motors 35 on the basis of a specific motion to raise and lower the slide 33. The load meters 38 sense the load exerted on the slide 33 when performing press molding. The motion generator 23 generates a correction motion S (an example of a second motion) from the basic motion S₀ on the basis of the decrease ΔF in load (an example of a change in load).

Thus, the basic motion S₀ is corrected on the basis of the change in load obtained as a result of performing press molding with the basic motion S₀, and a correction motion S that takes the change in load into account can be generated. The servo motors 35 can be driven with position control produced by the correction motion S, and press molding can be carried out under the proper load. That is, press molding under the proper load can be performed by position control.

With control of the servo motors 35 by position control, acceleration or deceleration is performed, but since there is no repeated starting and stopping as in the case of pressure control, the motor load is lower and servo motors with a smaller capacity can be employed.

Therefore, producing the correction motion S and performing press molding with this correction motion S allows press molding to be performed under the appropriate load at low cost, without using large capacity servo motors.

Also, since there is no need to adjust by trial and error, it is not necessary to consume extra materials to generate the proper motion, and costs can be reduced.

### 3. Other Embodiments

Embodiments of the present invention were described above, but the present invention is not limited to or by the above embodiments, and various modifications are possible without departing from the gist of the invention.

### (A)

In Embodiments 1 and 2, the two load meters 38 are attached to the crown 32, but the number is not limited to two, and just one load meter 38, or three or more load meters 38 may be provided. For example, the total load may be estimated from either one of the two load meters 38, or one load meter 38 may be disposed in the center in the left-right direction of the crown 32.

Furthermore, the load meters 38 need not be provided only to the crown 32, and may also be provided to the left and right uprights 31, for example.

### (B)

In Embodiments 1 and 2, a strain gauge is used as an example of a load meter, but this is not the only option, and a piezoelectric sensor may be used instead, for example.

Also, the load may be sensed by measuring the electrical load from the current flowing through the servo motors 35.

Also, if the press device 3 has a hydraulic overload protector at the connecting portion between the slide 33 and the plunger 368 or the like, then the load exerted on the slide 33 may be sensed by measuring the hydraulic pressure with a hydraulic pressure sensor.

In short, as long the load exerted on the slide 33 during press molding can be sensed, there are no restrictions on the location and type of load meter.

### (C)

In Embodiments 1 and 2, the slide 33 is supported by the two plungers 368, but the number of plungers 368 is not limited to two, and just one or three or more plungers 368 may be provided.

### (D)

In Embodiment 1, the motion generation device 2 need not store information about the press extension amount of the press device 3, and this information may be acquired from the press device 3, for example.

### (E)

In Embodiment 1, the motion generation device 2 receives the basic motion S₀ from the press device 3, but the motion generation device 2 may instead store the basic motion S₀.

### (F)

In Embodiment 1, the motion generation device 2 and the press device 3 communicate with each other, but communication may not be performed. For instance, the basic motion S₀, the load waveform data, or the correction motion S may be exchanged between the press device 3 and the motion generation device 2 using a recording medium such as an SD card. In this case, an example of the acquisition component of the motion generation device of the present invention is a reader that reads a recording medium.

### (G)

In Embodiments 1 and 2, a motion held at the lower limit position for a specific, required length of time is used as the basic motion S₀ during preliminary molding, but this is not the only option. The basic motion S₀ may be set so that the position of the slide 33 goes down as time passes. What is important is that the change in load can be sensed from the basic motion, and that the slide additional movement amount ΔS can be calculated on the basis of this change.

### (H)

Since Embodiments 1 and 2 involve the use of the basic motion S₀ that is held at its lower limit position P1 for a specific length of time, the change in the load is calculated as the load decrease amount, but if the shape of the basic motion S₀ is changed, the load may be increases in all or part of the duration of the basic motion S₀. In this case, with the correction motion S, the slide 33 is positioned higher than the basic motion S₀ so as to reduce the load during this time.

### (I)

In Embodiments 1 and 2, it is stated that the position of the slide 33 is higher than bottom dead center at the lower limit position of the basic motion S₀, but this is not the only option, and the slide 33 may be positioned at bottom dead center at the lower limit position.

In this case, the position of the slide 33 at bottom dead center may itself be set to be at or below the lower limit position of the correction motion S, with a slide position adjustment mechanism (not shown) or the like.

### (J)

In the above embodiments, an example of a motion generation method was given in which the motion generation method was performed in accordance with the flowchart shown in FIG. 3 and the flowchart shown in FIG. 10, but this is not the only option.

For instance, the present invention may be implemented as a motion generation program that causes a computer to execute some or all of the steps of the motion generation method implemented according to the flowchart shown in FIG. 3 or 10.

The program of the present invention may be recorded to a storage medium such as a ROM that can be read by a computer.

Also, the program of the present invention may be a mode in which a program is transmitted over a transmission medium such as the Internet or through a transmission medium such as light or radio waves, read by a computer, and operates in conjunction with a computer.

As described above, the function setting method may be realized by software or by hardware.

The motion generation device, press device, motion generation method, and motion generation program of the present invention have the effect of making it possible to perform press molding under the proper load while keeping the cost low, and is useful in CFRP press molding, for example.

1. A motion generation device for generating motion of a slide in a press device configured to perform press molding by driving the slide up and down using a servo motor as a drive source, the motion generation device comprising:
an acquisition component configured to acquire data related to a change in a load exerted on the slide in press molding using a first motion; and
a second motion generator configured to generate a second motion from the first motion based on the change in the load.

2. The motion generation device according to claim 1, wherein
the second motion generator includes
a correction amount calculator configured to calculate a correction amount for the first motion based on the change in the load,
a second motion calculator configured to use the correction amount to calculate the second motion from the first motion.

3. The motion generation device according to claim 2, wherein
the correction amount calculator is further configured to calculate the correction amount so as to suppress the change in the load.

4. The motion generation device according to claim 3, wherein
the change in the load is a decrease from a preset value for the load.

5. The motion generation device according to claim 3, further comprising:
a change amount calculator configured to calculate an amount of change in the load from data related to the change in the load,
the correction amount calculator being further configured to
find an extension amount from the amount of change in the load based on a relation between an amount of extension of an entirety of the press device and the load exerted on the slide, and
use the amount of extension amount as correction amount, and
the second motion calculator being further configured to calculate the second motion so as to move the slide from the first motion by an amount corresponding to the correction amount.

6. The motion generation device according to claim 5, wherein
the amount of change in the load is an amount of decrease in the load, and
the second motion calculator moves the slide downward from the first motion by an amount corresponding to the correction amount.

7. The motion generation device according to claim 1, wherein
the first motion is a motion for controlling the servo motor so as to hold the slide at a lower limit position for a specific length of time necessary for the press molding of a material.

8. A press device for press molding a material using an upper die and a lower die, the press device comprising:
a slide having a lower face attachable to the upper die;
a servo motor configured to be used as a drive source for the slide;
a servo controller configured to control the servo motor based on a specific motion to raise and lower the slide;
a load sensor configured to detect load exerted on the slide in press molding; and
a second motion generator configured to generate a second motion from the first motion based on a change in the load exerted on the slide in press molding using the first motion.

9. A motion generation method for generating motion of a slide in a press device configured to perform press molding by driving the slide up and down using a servo motor as a drive source, the motion generating method comprising:
generating a second motion from a first motion based on a change in load exerted on the slide in press molding using the first motion.

10. The motion generation method according to claim 9, further comprising:
calculating a correction amount of the first motion based on the change in the load exerted on the slide in press molding using the first motion; and
calculating the second motion from the first motion using the correction amount.

11. A motion generation program for generating motion of a slide in a press device configured to perform press molding by driving the slide up and down using a servo motor as a drive source, the motion generating program comprising:
executing a motion generation method with a computer in which a second motion is generated from a first motion based on a change in load exerted on the slide in press molding using the first motion.
